(19) United States
(12) Patent Application Publication
(10) Pub. No.: US 2006/0153229 A1
(43) Pub. Date: Jul. 13, 2006

(54) System and method for extended distance digital subscriber line based services

(75) Inventors: Patricia A. Cohen, Rowlett, TX (US); David A. Taylor, Dallas, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, LP

(21) Appl. No.: 11/032,494

(22) Filed: Jan. 10, 2005

(51) Int. Cl. H04J 3/16; H04J 3/04

(52) U.S. Cl. 370/466; 370/535

(57) ABSTRACT

A system and method is disclosed to provide data services to subscribers who are remotely located from a central office (e.g. greater than about 16,000 ft). A remote service area interface (“SAI”) is placed proximate to the remote subscribers and the SAI facilitates long distance communications. The SAI has a first interface that can be connected to numerous subscribers and a second interface that can be connected to a central office. The system and method can effectively provide services utilizing existing telephone lines between the subscribers and the central office. The SAI can also receive power over existing telephone lines from the central office.

### FIELD OF THE DISCLOSURE

The present disclosure relates generally to extending the distance of digital subscriber line data service from a central office.

### BACKGROUND

Digital subscriber line (“DSL”) services have quickly emerged as a high quality solution for high-speed Internet access and other services associated with high-speed Internet services, such as voice over Internet protocol (“VoIP”) and streaming video services. DSL can transmit voice and data over existing paired copper wires reliably up to about 16,000 feet from a central office. A central office may be a telecommunications office that is equipped to handle phone service for a locality. Since DSL can utilize existing copper telephone lines, the connection and service costs associated with DSL is relatively low for service providers and customers. Moreover, since data can be transmitted relatively quickly using DSL, it is an attractive option for providing high-speed access to end-users.

Traditional plain old telephone service (“POTS”) uses a narrow 4-kHz baseband frequency to transmit analog voice signals, and current modem technology can achieve a data transmission rate of up to 56 kb/s. DSL (e.g., asymmetric DSL (“ADSL”)), can increase the usable frequency range from 4 kHz to 1.1 MHz and can provide a data transmission rate up to 8 Mb/s. Further, frequency division multiplexing (“FDM”) can allow ADSL to create multiple frequency bands that can be used to carry data simultaneously with POTS traffic over the same copper pair. The lower 4 kHz frequency range is reserved for POTS, the middle frequency band is used to transmit upstream data, and the larger, higher frequency band is used to transmit downstream data, hence the name “asymmetrical.”

When service companies attempt to connect subscribers who are greater than about 16,000 feet from a central office, many technical difficulties can be encountered. Weak signal strength and excessive noise degrade a signal such that reliable transmission of data is difficult. Further, frequent data errors can occur, requiring retransmission of data. Retransmission of data results in increased peer-to-peer communications, further slowing the data transmission rates. Some long service lines experience error rates severe enough to cause service interruption or the inability to establish the data channel requested by the customer.

DSL performance is dominated by two major factors, insertion loss caused by the transmission cable connecting the subscribers' ADSL modems to the central office and electronic noise that reduces the signal to noise ratio at the modem receivers. At the maximum approved distance for DSL service, both noise components are typically at or above desired levels.

Accordingly, there is a need for a system and method to extend DSL services.

### BRIEF DESCRIPTION OF THE DRAWINGS

FIG. 1 is a diagram of an exemplary DSL network;

FIG. 2 is a flow chart to illustrate an exemplary method for extending DSL services to subscribers; and

FIG. 3 is a flow chart to depict an exemplary method for providing extended DSL services to subscribers.

### DETAILED DESCRIPTION OF THE DRAWINGS

A system and method is disclosed to provide DSL services to customers who are remotely located from a central office (e.g., greater than about 16,000 feet), or alternatively, provide DSL services from a central office that is remotely located from a group of subscribers. A service area interface (“SAI”) is placed proximate to the subscribers and the SAI can facilitate long distance DSL communications in a locality. The SAI has a first interface that can be connected to numerous subscribers and a second interface that can be connected to a remote central office. In a particular illustrative embodiment, the first interface can communicate with the subscribers utilizing an ADSL line format and the second interface can communicate with the remote central office utilizing a high-speed digital subscriber line (“HDSL”) format. The system and method can effectively provide communication services utilizing existing telephone lines between the subscribers and the remote central office. The SAI can also receive power over existing telephone lines from the remote central office. An SAI can be placed many miles from the central office and provide many remote subscribers with DSL service over conventional copper twisted pair conductors.

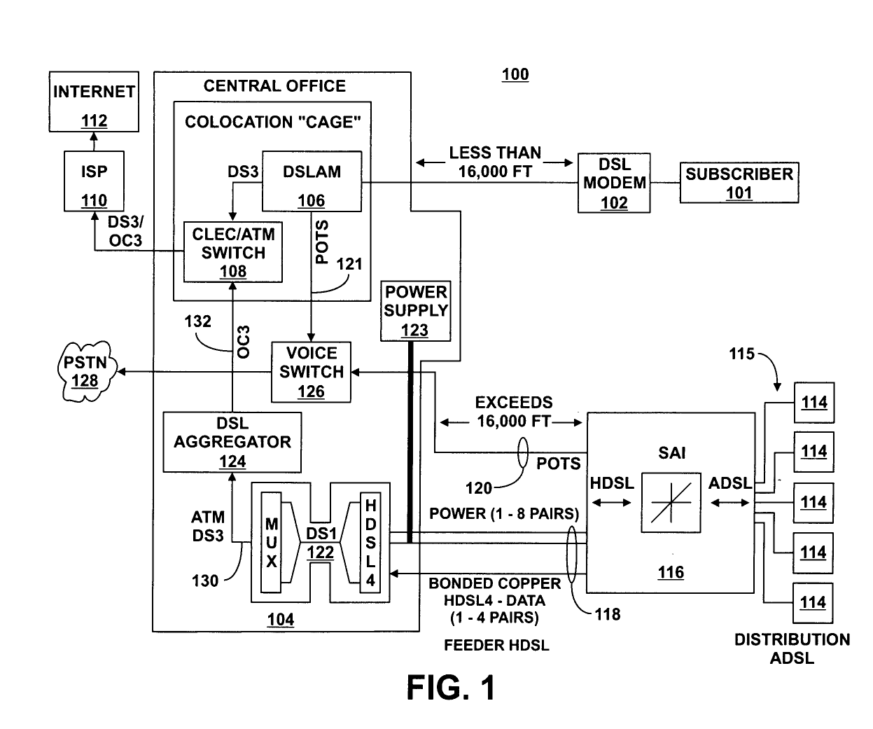

Referring to FIG. 1, an exemplary, non-limiting embodiment of a communication network 100 is shown. A first subscriber 101 is coupled to a standard digital subscriber line (DSL) modem 102 that is coupled to central office 104. The central office 104 includes a first DSL access module (DSLAM) 106 that is coupled to a voice switch 126 and to a competitive local exchange carrier/asynchronous transfer mode (“CLEC/ATM”) switch 108. The voice switch 126 can be coupled to PSTN 128. CLEC/ATM switch 108 is coupled to an Internet service provider (ISP) 110 and ISP 110 is coupled to Internet 112. A plurality of subscribers 114 can be connected to service area interface (“SAI”) 116. The SAI is coupled via long distance POTS lines 120 to the voice switch 126 and via HDSL lines 120 to a high-speed digital subscriber line (“HDSL”) interface 122. HDSL interface 122 is coupled to the CLEC/ATM switch 108 via DSL aggregator 124.

The first subscriber 101 can be coupled to the communications network 100 utilizing a standard DSL modem 102 interconnected via the first DSLAM 106 within the central office 104. Power in the subscriber's home, such as AC electric power; is typically utilized to power the standard DSL modem 102. Where the subscriber 101 has Internet access, part of the data transmitted and received is voice data and part is computer data. The first DSLAM 106 can separate the voice data from the computer data and send the voice data over the POTS line 121 to the voice switch 126. The non-voice computer data can be re-transmitted by the first DSLAM 106 utilizing a broadband technology or a higher bandwidth technology, such as DS3, to the CLEC/ATM switch 108 to transmit numerous messages simultaneously when communicating with the ISP 110. The ISP 110 provides a gateway to the Internet 112. The first subscriber 101 is located within a distance from the central office 104 that is close enough such that standard DSL technology may be utilized to provide effective communication between the central office 104 and the first subscriber 101 (e.g., less than about 16,000 feet).

A plurality of subscribers can be located several miles from the nearest central office 104. For example, the central office 104 can be remotely located from subscribers 114 (i.e., requiring more than three miles or 16,000 feet of copper wire for interconnection), which is beyond the capability of standard DSL communication topologies.

To provide extended range DSL services, a second port of SAI 116 can be placed near the subscribers 114 and connected over extended lines to the remote central office 114 to aid in providing reliable DSL services to the plurality of subscribers 114. The SAI 116 can provide reliable data streams and communication when the subscriber 114 is located an extended distance, such as in excess of 18,000 or in excess of 20,000 feet, from the remote central office 104.

In an illustrative embodiment, as many as 400 subscribers 114 can utilize ADSL technology to communicate with the SAI 116 at a first port over electrically conductive lines 115 such as four twisted copper pairs. The electrically conductive lines 115 can be copper lines, twisted in pairs in accordance with existing telephone systems. Spare or unused copper pairs are commonly found in neighborhoods and on main communication trunks and can be utilized to implement remote DSL communications. The disclosed system can be implemented without the need to install additional copper lines. The SAI 116 can function as a multiplexer, an ADSL terminating unit, an amplifier, and/or a data converter. In a particular embodiment, the SAI 116 can convert ADSL data received from the subscribers 114 into high-speed digital subscriber line (“HDSL”) format data or other broadband format. The SAI 116 can also separate voice data from computer data and send the voice data over the POTS line 120 to the remotely located voice switch 126. The voice switch 126 can send the voice data to the PSTN 128.

The computer data that is transmitted by the remote subscribers 114 to the SAF utilizing the ADSL format can be converted into an HDSL data stream at the SAI 116. The HDSL data can be transmitted over bonded copper lines 118, utilizing an HDSL 4 configuration. The SAI 116 can have an interface to receive power. For example, bonded copper lines 118 can be coupled to the interface of the SAI 116 to supply power to the SAI 116. A power supply 123 located within the central office 104 can be coupled at a far end to the bonded copper lines 118 to provide power to the SAI 116. This configuration allows the SAI 116 to be placed nearly anywhere and eliminates the need for “power drops” that are costly and require power meters. In alternate embodiments, a service drop (not shown) may be utilized to provide power to the SAI 116.

A broadband receiver, such as a second DSLAM 122 within the central office 104, can receive the subscriber data in the HDSL 4 format and switch and multiplex the HDSL4 data. The data can be converted from the HDSL format into ATM format at the CLEC/ATM switch 108. A DS3 line 130 can provide subscriber data to the DSL aggregator 124 and the DSL aggregator 124 can combine many ATM channels (not shown) and communicate over an optical carrier (“OC”) 132. For simplicity, one ISP 110 and five subscribers 114, respectively are shown. Many businesses or corporate networks may be connected to the central office 104 and a large number of ISPs or corporate networks can be connected to the central office 104.

In a particular embodiment, the remote subscriber to SAI portion of the network may utilize many different versions of DSL, such as ASDL, ADSL2, ADSL2+. Likewise, a higher bandwidth connection may be implemented utilizing many different configurations, such as very high data rate or DSL (“VDSL”), or standard HDSL. FIG. 1 shows many residential subscribers 114 supported by a data connection in a particular exemplary, non-limiting embodiment. A number of computers and telephones may also be located within a business (not shown). In a particular embodiment, data can be transmitted over the network 100 using transmission control protocol/Internet protocol (“TCP/IP”), file transfer protocol (“FTP”) (e.g., for large files), user datagram protocol (“UDP”) (e.g., for VoIP and streaming video), or real-time transport protocol (“RTP”) (e.g., for streaming video files or streaming audio files).

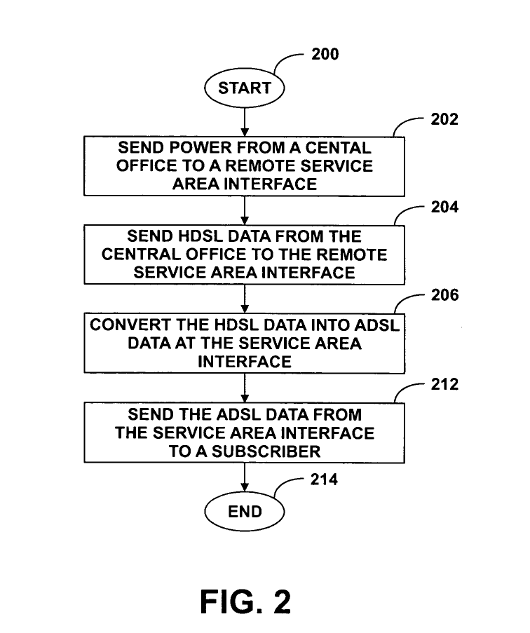

Referring to FIG. 2, a method of providing extended DSL services is shown. In a particular embodiment, the method can be utilized to provide DSL services to the subscribers 114 that are remotely located from a central office 104, as shown in FIG. 1. At step 200, the method begins and proceeds to step 202 where power is provided from a remote central office to a service area interface over copper lines. The remote central office can communicate data to the service area interface utilizing a broadband connection, such as an HDSL configuration, at step 204. The SAI unit can convert the data from the HDSL format into a different format, such as an ADSL format, at step 206. The service area interface can transmit the converted data in ADSL format to the subscriber, via a subscriber telephone line connected to a subscriber computer device, as illustrated at step 212. The process ends at step 214. The method allows a DSL connection between a subscriber's DSL modem and the remote central office. As a subscriber computer device is brought on-line via a remote connection, authorizations may be required to establish DSL service for the subscriber computer. In a particular embodiment, a start-up communication process can be encapsulated in a software program that can be executed by the subscriber's computer to control modems in the network in order to provide enhanced performance of each DSL circuit. While the method illustrated in FIG. 2 describes data originating at a central office being communicated to a remote subscriber, it should be understood that data originated at a subscriber may be communicated to the central office using extended range DSL.

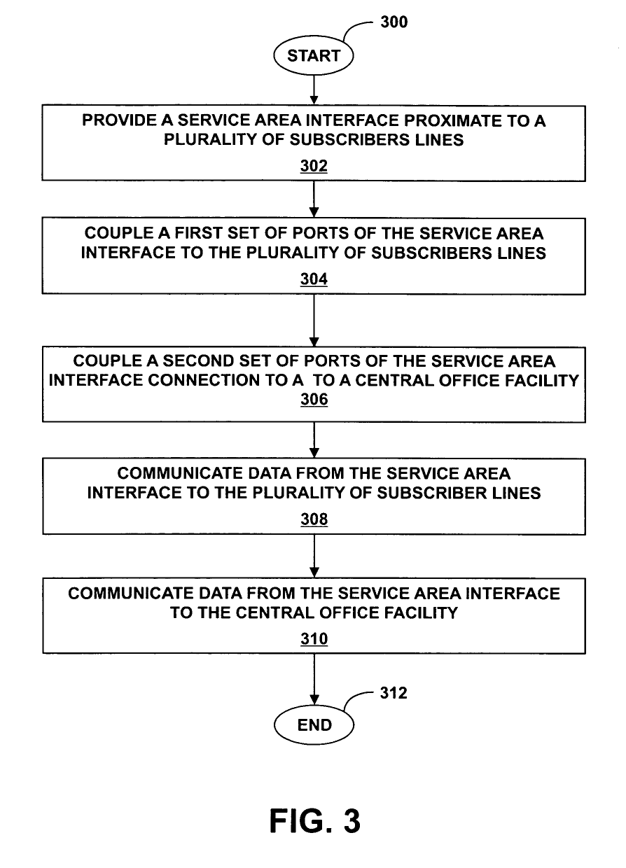

Referring to FIG. 3, a method of providing extended DSL services is depicted. The method starts at 300 and proceeds to step 302 where an SAI is located proximate to a plurality of subscriber lines. A first set of ports of the SAI are coupled, via transmission lines, to the subscriber lines at step 304 and a second set of ports are coupled, via transmission lines, to a remote central office at step 306. Data can be communicated from the SAI to a plurality of subscribers via the plurality of subscriber lines at step 308. Data can also be communicated from the SAI to the remote central office, as shown in step 310. The remote central office can be located more than 1600 feet away from the subscribers. The process ends at 312.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A communication system comprising:
a service area interface having a first interface configured to couple to a plurality of subscriber lines and a second interface configured to communicate with a remote central office; and
wherein the first interface is configured to communicate with the plurality of subscriber lines utilizing an asymmetrical digital subscriber line format and the second interface is configured to communicate with the remote central office utilizing a high-speed digital subscriber line format.

2. The system of claim 1, wherein an electrically conductive media is utilized by the service area interface to transmit data to the remote central office.

3. The system of claim 1, wherein the service area interface further comprises a interface configured to receive power.

4. The system of claim 1, wherein the service area interface can multiplex between up to 400 subscribers and four twisted pair conductors.

5. The system of claim 3, wherein the service area interface receives power from the remote central office.

6. The system of clam 1, wherein the service area interface receives power from a plurality of telephone wires coupled to the remote central office.

7. The system of claim 1, wherein the service area interface multiplexes data received from the plurality of subscriber lines.

8. A method of communicating subscriber data, the method comprising:
receiving subscriber data streams having a first format over a first set of channels;
converting the received data streams having the first format to a second data stream having a multiplexed high-speed digital subscriber line format; and
transmitting the second data stream having the multiplexed high-speed digital subscriber line format over a second set of channels to a remote central office.

9. The method of claim 8, wherein each of the second set of channels provides a greater communication bandwidth than each of the first set of channels.

10. The method of claim 8, wherein the second set of channels are broadband channels.

11. A communication system comprising:
a service area interface comprising a first set of ports coupleable to a plurality of subscribers and a second set of ports coupleable to a remotely located broadband receiver located more than 16,000 feet away from the second set of ports.

12. The system of claim 11, wherein the service area interface is coupled to the remotely located broadband receiver via a bonded copper line.

13. The system of claim 11, further comprising a data converter to convert data in a first format into broadband data in a second format.

14. The system of claim 11, further comprising an amplifier coupled to at least one of the second set of ports.

15. A method of communicating comprising:
transmitting data in a high-speed digital subscriber line format to a remote service area interface; and
converting the data in the high-speed digital subscriber line format into asymmetrical digital subscriber line format data at the remote service area interface.

16. The method of claim 15, further comprising providing power to the remote service area interface.

17. The method of claim 15, wherein the remote service area interface is located more than 18,000 feet from a central office.

18. The method of claim 15, wherein the data in the high-speed digital subscriber line format is transmitted from a central office.

19. A method comprising:
providing a service area interface proximate to a plurality of subscribers lines;
coupling a first set of ports of the service area interface to the plurality of subscribers lines;
coupling a second set of ports of the service area interface to a communication link to a remote central office facility;
communicating data from the service area interface to the plurality of subscriber lines;
communicating data from the service area interface over the communication link to the remote central office facility; and
wherein the service area interface is located more than 16,000 feet away from the central office.

20. The method of claim 19, wherein the service area interface is located more than 18,000 feet away from the remote central office.

21. The method of claim 19, wherein the service area interface is located more than 20,000 feet away from the remote central office.

22. The method of claim 19, further comprising communicating data over a network selected from the group consisting of an asymmetric DSL (“ADSL”) network, an ADSL 2 network, an ADSL 2+ network, a very high data transfer rate DSL (“VDSL”) network, and a VDSL 2 network.
